(19) United States
(12) Patent Application Publication
(10) Pub. No.: US 2006/0263515 A1
(43) Pub. Date: Nov. 23, 2006

(54) Method for Removing Minor Lacquer Imperfections

(75) Inventors: Klaus Rieck, Braunschweig (DE); Lutz Siedentopf, Wolfsburg (DE)

Correspondence Address: NORRIS, MCLAUGHLIN & MARCUS, P.A., 875 THIRD AVE, 18TH FLOOR, NEW YORK, NY, 10022, US

(73) Assignee: VOLKSWAGEN AKTIENGESELLSCHAFT, Wolfsburg (DE)

(21) Appl. No.: 11/383,978

(22) Filed: May 18, 2006

Related U.S. Application Data
(63) Continuation-in-part of application No. 10/221,615, filed on Nov. 25, 2002, now abandoned.

(30) Foreign Application Priority Data
Mar. 16, 2000 (DE) 100 12 752.5
Oct. 26, 2000 (DE) 100 53 141.5
Nov. 7, 2000 (DE) 100 55 045.2

(51) Int. Cl. B05D 3/00; B05D 1/02; B32B 43/00

(52) U.S. Cl. 427/140; 427/421.1; 427/299

(57) ABSTRACT

The invention relates to a method for repairing lacquer imperfections, especially minor lacquer imperfections of body paints. The lacquer is removed in the imperfect area in a very small spot down to a predetermined depth, preferably in a crater form shape and the imperfect spot is then concealed by repainting it so that it is almost invisible to the human eye. The lacquer is preferably removed in an area that extends beyond the imperfect spot only by maximally few millimeters and down to a coloring base lacquer layer below the clear coat or a filler layer present below said base lacquer layer. Repainting comprises preferably applying a color lacquer layer in the sand-blasted area, filling the dent in the lacquer with a clear coat, overspraying the imperfect spot with a color lacquer and applying a protective clear coat layer.

This application is a continuation-in-part of U.S. Ser. No. 10/221,615, filed Nov. 25, 2002, which is a section 371 of PCT/EP01/02250, filed Feb. 28, 2001.

The present invention is directed to a method for repairing lacquer imperfections, in particular minor lacquer imperfections of automobile body paints, wherein the lacquer is removed in the imperfect area down to a predetermined depth, so that the lacquer imperfection is at least partially removed and an indentation produced by the removal is repainted. The invention is further directed to a method for filling corresponding lacquer repair locations or lacquer indentations, in particular with effect lacquers, with a suitable repair lacquer and to an overspray process for lacquer repair locations that have already been filled with lacquer containing a coloring lacquer that conceals the repair location. The invention further relates to a special lacquer application method, a particular for automobiles, for providing an optimally suited coloring lacquer for carrying out these methods. The invention finally is directed to a protective foil that can be used with the methods for covering the lacquer area surrounding the imperfect area.

When automobiles are painted, small lacquer defects or imperfections are regularly observed which are quite noticeable and must therefore be later removed to render them invisible to the human eye. These imperfections can be surface imperfections in an outer protective clear coat, for example, in the form of lacquer bumps or pimples, which can be later removed by sanding and subsequent polishing of the sanded areas. The imperfections can also be present below and/or or within the clear coat and can be quite noticeable through the clear coat, so that they cannot be removed by simply smoothing out the clear coat layer. Conventionally, such imperfections are therefore initially sanded down over a large area, whereby the sanded area typically has a size of a human hand. This large area is subsequently repainted, with the paint bleeding out towards the edge. Such large area has to be repainted so that the eye of a viewer will no longer be able to resolve the transitions to the original lacquer surrounding the imperfection. In this so-called “spot-repair-process”, the vehicle is during repainting almost totally or totally covered or masked with foils and the like, except for the actual imperfection, to protect the remaining lacquer, making repairing the imperfection extremely labor-intensive and expensive. In another no less expensive process, the entire affected part is repainted by so-called “whole part” painting.

It is the object of the present invention to provide a less labor-intensive, simpler, faster and more cost-effective method of the aforedescribed type for removing or concealing lacquer imperfections, to make them unnoticeable and almost invisible for the human eye. Essential aspects of this object and other limited objects include providing improved methods for removing lacquer imperfections, for filling lacquer indentations or lacquer repair locations with a suitable repair lacquer and for overspraying the lacquer repair locations with a coloring lacquer that conceals the repair location. A suitable method specifically for repairing imperfections in effect lacquer layers should also be provided. Additional important aspects of the object include providing a coloring lacquer that is optimally suited for carrying out these methods as well as a protective foil.

One aspect of the object is solved by the invention in that the lacquer is removed in an area with a diameter that is no greater than 10 times, and in a particular embodiment no greater than 5 times, the diameter of the lacquer imperfection. Accordingly, the lacquer is removed only over an extremely small area in the imperfect area or even around an almost point-shaped area. The removal hereby extends only at most several mm beyond the imperfection, so that the removal or treatment area can be kept very small in comparison to conventional methods and is practically no longer visible to the human eye after having been properly repainted according to the method of the invention described below. The diameter of the area from which the lacquer is removed is preferably only between 0.5 and 20 mm. Particularly advantageous result have been obtained with diameters between 0.6 and 10 mm, and more particular between 0.7 and 4 mm.

The lacquer is preferably removed down to a coloring base lacquer layer below the clear coat or to a filler layer located below the base lacquer layer, which in a conventional lacquer arrangement of an automobile lacquer corresponds to a removal depth of 55 to 75 μm. Even with deeper lacquer imperfections or inclusions down to the area of a katophoretic dip coat or KTL-layer located below the filler layer and serving as a corrosion protection, the imperfections can be concealed by the repair according to the invention of the filler, base and/or clear coat layer so as to be practically invisible. Although the lacquer can in this case be removed down to the KTL-layer or even to the metal below, certain problems can arise because the filler color is typically different from the color of the KTL-layer. Potential problems with the subsequent color restoration can be avoided by making the repair on an original filler background in the area of the filler layer or the base lacquer layer. With this method, the KTL-layer or the corrosion protection layer, which would otherwise have to be repaired or built up to prevent potential corrosion problems, remains intact, thereby obviating the need for additional process steps, which could result in longer repair times and/or increased repair costs.

The removal preferably produces a crater-like indentation with sides having a slope of approximately 30 to 95°, in particular of approximately 60 to 80°. Other values for the slope can also be selected; if the slope angles are too large or two small, problems can arise when the lacquer is removed and/or the generated crater is filled and concealed.

The lacquer is removed by drilling, milling or sanding, by jet blasting or by another suitable material removal method, for example, by a laser process. According to a particularly advantageous method, a sandblasting process is employed, wherein the removal process, i.e., the removal speed, the removal depth, and the shape and flank slope of the produced crater-shaped indentation, are controlled by selecting a blasting means and/or a quantity of a blasting material and/or a velocity of the blasting material and/or a jet blasting time in the sandblasting process. Particularly advantageous is a vacuum sandblasting process, wherein a vacuum is used for not only drawing in the blasting material through an acceleration path, but also for suctioning off the blasting material and removed lacquer particles, thereby reliably preventing potential damage to the lacquer surrounding the imperfect area by airborne lacquer or sand particles.

According to the invention, repainting of the imperfect area includes filling the produced lacquer indentation with a repair lacquer, i.e., applying only within the perimeter of the indentation itself at least one repair lacquer layer containing pigments, overspraying (concealing) the imperfect area with a coloring lacquer and applying a clear coat layer. The clear cloat layer may be applied preferably, but not necessarily, as overspraying. Advantageously, the repair lacquer layer can be applied either as a mixture of a coloring lacquer and a clear coat or as successively applied coloring lacquer and a clear coat layers. In this context, the term coloring lacquer or color lacquer refers to a lacquer that contains color pigments and optionally effect pigments. A repair location that more closely matches the surrounding original lacquer can in both cases be produced by thinning the color lacquer fraction in the repair lacquer with the clear coat and/or the clear coat layer, as will be described below in more detail. A coloring lacquer of the original lacquer surrounding the area to be repaired or a coloring lacquer of the same lacquer batch is used as a coloring lacquer for both the repair lacquer and for overspraying. Light-crosslinked, so-called UV clear coats have proven effective as clear coats for the repair lacquer and/or for the finish clear coat due to their desirable excellent shrinkage characteristic. Preferably, a precision spray device is used for applying the various lacquer layers, after the imperfect area has been cleaned with an isopropanol/water mixture. The imperfect area can also be sanded and/or polished before and/or after overspraying and/or application of a clear coat.

Before a lacquer layer is removed, sanded down, polished and/or or applied, however more particularly before the imperfect area is removed, the lacquer area surrounding the imperfect area is covered with a protective foil having an opening that leaves open only the imperfect area and the immediate surrounding area. The actual treatment area in the following removal, sanding, repainting and/or polishing process steps, in particular the diameter of the removal area, is defined by the size and shape of the opening in the protective foil. The protective foil is further intended to protect the extended surroundings of the imperfect area from undesirable effects caused by the treatment, in particular from color mist and mechanical damage. By working according to the invention over a small area and using precision instruments for removal and painting, the foil needs to have only a very small size. The conventional method of covering the lacquer repair location with large-area adhesive foils is thereby obviated. Intrusive lacquer imperfections can hence be removed over a very small area or even in a point-shaped area, and can be kept imperceptible and almost invisible to the human eye. Corresponding protective foils are also suitable for curved surfaces and can thus be easily employed in the automobile industry. After the lacquer imperfection has been treated or, if necessary, following one of the required intermediate steps, in particular before overspraying, the pressure-sensitive or self-adhesive protective foil is simply pulled off the lacquer layer without leaving a residue.

The diameter of the substantially circular opening arranged centrally in the protective foil of the invention is suitably selected for the individual lacquer imperfections depending of the size of the imperfection and is typically 0.5 to 4.0 mm. Particularly advantageous, i.e. almost invisible, repair results can be obtained with an opening in the protective foil of 0.8 to 2.0 mm.

For example, the protective foil can have a square or circular size with an edge length between approximately 25×25 mm² and approximately 100×100 mm², in particular between approximately 40×40 mm² and approximately 60×60 mm². Other embodiments, such as circular protective foils with corresponding diameters are also feasible.

In an advantageous embodiment, the protective foil includes markers indicating the position of the opening, advantageously with cross-shaped marker lines and the like, to facilitate and improving positioning lacquer imperfections in the center of the opening. In addition, the protective foil according to the invention is preferably colored and/or transparent, wherein the coloration of the foil is selected to be different from the color of an original lacquer layer surrounding the repair location, so that it can also be used to mark the lacquer imperfection. Due to the thinness of foils, the protective foil is preferably applied to a substrate and distributed already sorted according to opening diameters and colors and ready for separation from the substrate.

Application of the protective foil on the lacquer is facilitated significantly by using a pressure-sensitive or self-adhesive foil. The material of the protective foil and an optional adhesive coating should be adapted to certain requirements. The foil should be easily removable from the lacquer layer without leaving a residue to eliminate post-treatment steps. On the other hand, the foil material should be selected to withstand mechanical stress, for example during sandblasting, which is typically performed for 50 sec under a vacuum of 20 mbar, without being perforated. The adhesion of the foil must also be sufficient to prevent a partial release. Finally, neither the foil nor the adhesive coating should be insoluble in a lacquer used for repainting and/or a solvent

To improve handling, the protective foils are preferably provided with a handle device or a so-called “gripper” which can be, for example, in the form of a one-sided or multi-sided, non-pressure-sensitive or non-self-adhesive edge reinforcement. Other embodiments can are be contemplated.

The repair of the imperfection becomes less noticeable by improving the match between the color appearance of the repair location and that of the surrounding original lacquer. The color appearance can be characterized in a color metric by the color hue defined by the wavelength, the color saturation and the brightness. As discussed above, the color hue can be exactly matched by using for the repair or overspraying lacquer, if possible, the same color lacquer as the original lacquer. The color condition is determined by the totality of the color pigments of the individual overlapping covering layers or of the effect pigments for effect lacquers. To match the color appearance of the original lacquer as closely as possible, the repair lacquer applied in the indentation and the oversprayed color lacquer are therefore matched so that the sum of the color pigments and/or effect pigments of the repair lacquer layer applied in the indentation and of the oversprayed color lacquer layer corresponds to 85 to 115% of the sum of the number of particles of color pigments and/or effect pigments of the original lacquer surrounding the repair location, with reference to an axis oriented perpendicular to a lacquer surface. In an optimal case, the number of particles of pigments is different by a most ±3% from that of the original lacquer. The sum of the number of particles of pigments is referenced to an axis extending perpendicular to the lacquer surface, i.e., the total lacquer depth. Furthermore, a fraction of the particles of color pigments and/or effect pigments of the repair lacquer layer applied in the indentation is selected so that the sum of the number of particles of color pigments and/or effect pigments of the repair lacquer layer corresponds to 50 to 95%, preferably 65 to 92%, of the sum of the number of particles of color pigments and/or effect pigments of a color lacquer layer of the original lacquer. Even better results are obtained with a repair lacquer layer that contains 75 to 90% of the sum of the number of particles of pigments of the original lacquer. The aforedescribed fractions can be adjusted by adjusting the corresponding fractions of the color lacquer of the repair layer and/or by suitably thinning with clear coat. It is important that in each case this sum of the number of particles of pigments of the repair lacquer layer is smaller than in the original lacquer layer so as to be able to augment the missing saturation by properly configuring the color lacquer layer that is sprayed over the repair location. The latter is achieved by suitably selecting the thickness of the color lacquer layer. Preferably, a repair lacquer with at least the same brightness as the original lacquer layer is applied, with the color appearance of the repair lacquer to be corrected later by overspraying, since it is rarely possible to later correct by overspraying the color of a repair lacquer that is too dark.

The spatial orientation of the effect pigments in so-called effect lacquers makes it particularly difficult to repair small lacquer imperfections. Conventional effect pigments orient themselves preferably parallel to the substrate surface and parallel to each other due to their two-dimensional plate- or rod-like shape. The effect pigments also tend to orient themselves parallel to the surface near the surface area of the lacquer layer. In extended lacquer areas, the effect pigments therefore have a substantially ordered orientation which determines the optical appearance and which changes the reflectivity as a function of the viewing angle. When repairing small lacquer imperfections, the thinness of the repair lacquer layer, the uneven support base, as well as the small volume of the repair lacquer results in a different orientation of the effect pigments, which enhances the undesirable visibility of the repair location. According to a particularly advantageous method for filling a lacquer indentation or a lacquer repair location with effect lacquers, at least 80%, preferably 90%, of the number of particles of effect pigments of the repair lacquer layer are supposed to be oriented essentially parallel to the effect pigments of the original lacquer layer surrounding the repair location, i.e., parallel to the lacquer surface. Preferably, a major reflection plane of effect pigments of the repair lacquer layer deviates after drying by no more than 10°, in particular by no more than 5°, from a major reflection plane of the effect pigments of an original lacquer layer. This can be achieved with a method, whereby a surface tension of the effect-pigment-containing repair lacquer is adjusted, in particular by a suitable choice of a solvent, so that the repair lacquer after hardening forms an essentially flat surface, with a maximum height deviation relative to the surrounding lacquer level of at most 10 μm. More advantageously, the height deviation is at most 5 μm, in particular at most 1 μm. This eliminates pigment orientations that are caused by concave or convex surface distortions in the area of the repair location and that are hence different from the parallel orientation in the surrounding area.

According to another advantageous embodiment of the method, a repair lacquer containing effect pigments is applied with a reflectivity that is independent of a viewing angle. This can be approximately achieved by using for the repair lacquer effect pigments which instead of the typical rod- or plate-like shape have a three-dimensional shape, wherein an aspect ratio between two dimensions is 0.2 to 5, respectively. This can be an essentially tetrahedral, cubic, octahedral or another shape with essentially equal surfaces, or a spherical shape. Such pigments have either no or only an insignificant tendency to orient themselves and hence have a substantially direction-independent reflectivity.

Preferably, for filling the crater, a repair lacquer is applied which has a shrinkage that is more than 30% smaller, in particular more than 50% smaller, than the shrinkage of the color lacquer of the original lacquer layer surrounding the repair location. This can be achieved with a repair lacquer with a solid content greater than approximately 40%, in particular greater than approximately 50%.

According to the invention, the repair lacquer is applied so thick that the repair location relative to the surrounding lacquer level has a deviation, in particular an increased height, of at most 10 μm. Particularly advantageous results are obtained with deviations of at most 5 μm, and more particularly of at most 1 μm.

As mentioned already several times, the repair lacquer contains a coloring pigment-containing lacquer and clear coat which is used as a volume-filling material. Accordingly, the aforedescribed properties of the repair lacquer, such as color hue, color appearance, color saturation, brightness, reflectivity and shrinkage characteristics, refer in general to the sum of the color lacquer and clear coat, regardless if these are applied as a mixture or as separate layers.

When overspraying the lacquer repair location, a color lacquer is applied according to the invention which has a higher pigment density that the repair lacquer, wherein preferably color lacquer of the original lacquer surrounding the repair location or at least a color lacquer of the same lacquer batch is used. In this way, the color appearance can be particularly well matched to that of the surrounding original lacquer. The oversprayed area has preferably a diameter of less than approximately 20 mm, in particular less than approximately 10 mm, and has therefore substantially less area than is customary with conventional methods. It should be clear from the above that “overspraying” refers to an area which is greater than the area (perimeter) of the indentation or crater itself, i.e. about 2-4 mm as set out below, but which is within the above mentioned preferable outer limit of about 20 mm or less. The color layer applied by overspraying has a thickness of between approximately 5 and 75%, preferably between 5 and 50%, in particular between approximately 10 and 25%, of the thickness of coloring layer of the original lacquer layer surrounding the repair location.

Overspraying the repair location with coloring lacquer in an oversprayed area having a diameter of, in particular, less than 10 mm, is preferably performed by shadowing the area surrounding the repair location with a mask positioned at a distance to the surface, which mask is applied before the overspraying. A suitable mask includes two superpositioned foils arranged on the lacquer surface and having overlapping openings. The opening of a foil facing the lacquer and defining a spacing has a larger diameter than that mask opening of the upper foil determining the overspray area. A preferred diameter of the mask opening for attaining an overspray area of less than 10 mm is 1 to 5 mm, in particular 2 to 3 mm. At the same time, a foil thickness of the foil facing the lacquer of 0.5 to 2.0 mm, in particular 1 mm, has proven to be particularly advantageous. This foil thickness determines the spacing between the mask opening and the lacquer surface which ensures an almost continuous bleeding of the oversprayed area.

Since for repainting, i.e., for filling or overspraying the lacquer repair location, preferably a color lacquer of the original lacquer surrounding the repair location or at least a lacquer of the same lacquer batch is used as a coloring lacquer, it is further proposed according to the invention that when using a conventional lacquer application method a certain quantity of the coloring lacquer used for painting or of the respective lacquer batch is always set aside and stored for a possible paint repair that may be required at a later time.

Additional details, features and advantages of the present invention are not only recited in the appended claims—either alone or in combination—, but can also be inferred from the following description of the preferred embodiments of the invention to be read in conjunction with the appended drawings.

The drawings show in:

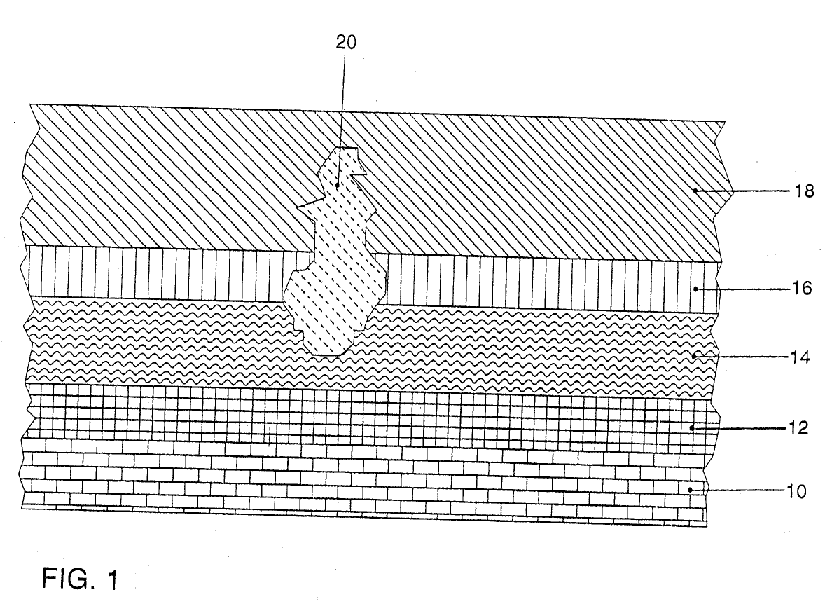

FIG. 1 in a greatly enlarged scale, a schematic diagram of a cross-sectional view through an automobile lacquer layer with a typical lacquer imperfection in form of a foreign inclusion;

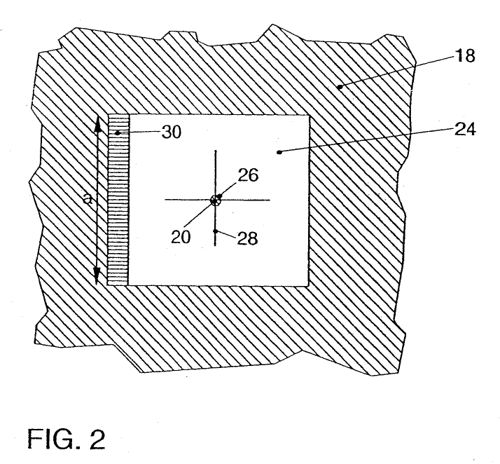

FIG. 2 in an approximately original scale, schematically a top view of a protective foil applied on an imperfect area;

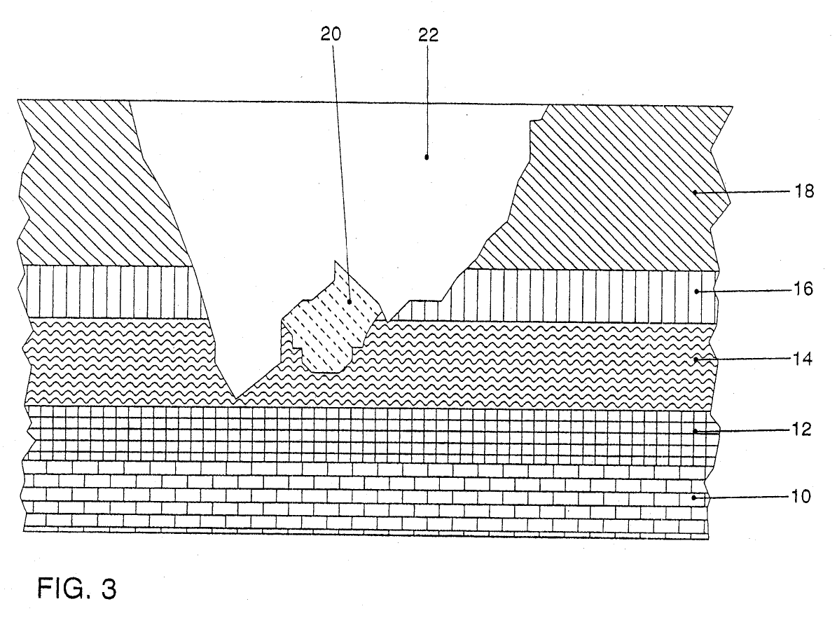

FIG. 3 the diagram of FIG. 1 with a crater-shaped indentation introduced into the lacquer in the imperfect area according to the invention;

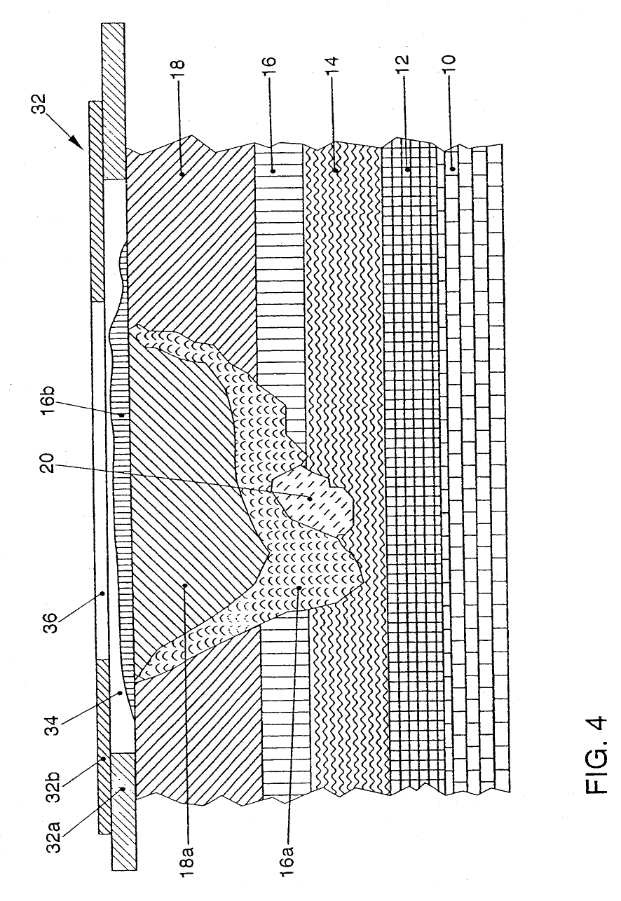

FIG. 4 the diagram of FIG. 3 with the imperfect area filled in and oversprayed, and with an applied adhesive mask; and

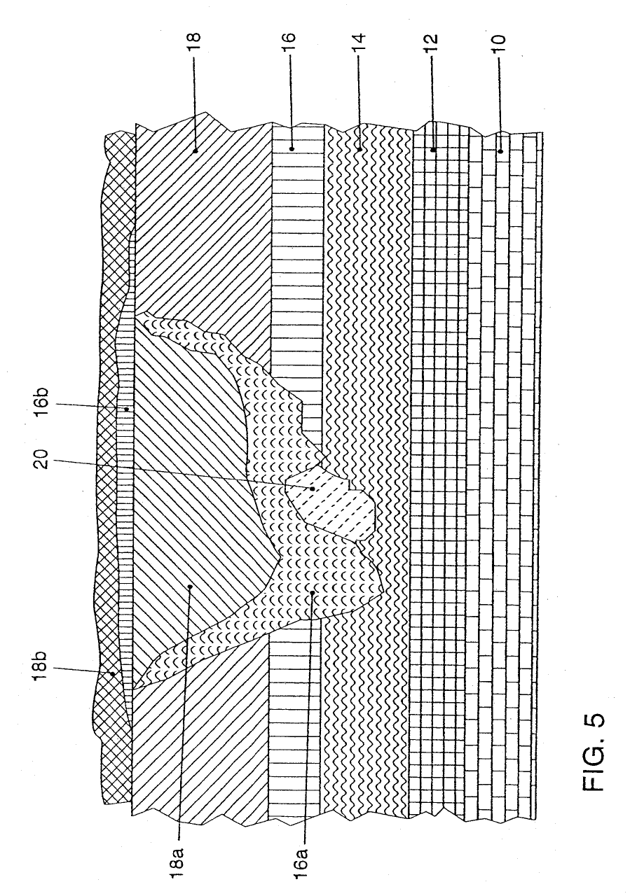

FIG. 5 the diagram of FIG. 4 with the imperfect area repainted according to the invention for covering the foreign inclusion.

The lacquer according to FIG. 1 includes a corrosion protection layer or KTL layer 12 with a thickness of approximately 17 to 22 μm, followed by a filler layer 14 with a thickness of approximately 30 to 40 μm, a coloring base lacquer layer 16 with a thickness of approximately 12 to 30 μm, and a protective clear coat 18 with a thickness of approximately 35 to 40 μm. A lacquer imperfection 20 having the form of a small foreign inclusion, which is almost “point like” in comparison to the size of the automobile, is located in the base lacquer layer 16 and the filler layer 14, and extends into the clear coat 18. In spite of its small size, the foreign inclusion is quite visible to the human eye through the clear coat 18 and should therefore be repaired using a suitable correction or repair method, such as, for example, the repair method according to the invention described below, and/or should at least be concealed so as to be almost invisible to the human eye. The lacquer layer would then appear to be perfect without visible lacquer imperfections which may otherwise reduce the value of the automobile.

Before the repair work according to the invention begins, the surrounding area of the lacquer imperfection or repair location is—as illustrated in the top view of FIG. 2—first covered by a protective foil 24 with the opening 26 that leaves only the imperfect area unobstructed, so that the surrounding lacquer area is reliably protected from possible damage or treatment marks. It is hence unnecessary to cover the entire vehicle—or almost the entire vehicle—over large areas with an adhesive foil, as is customary in conventional repair work. The protective foil 24 is made of a suitable plastic, preferably a self-adhesive plastic, and has a square shape with sides having a length a of approximately 50×50 mm², with a circular center opening 26 with a diameter of approximately 2 mm. The protective foil 24 is applied to the clear coat layer 18 so that the lacquer imperfection 20 is located in the center of the opening 26. The protective foil 24 has a cross-shaped mark 28 indicating the center of the opening 26. The mark 28 marks the opening 26 and facilitates positioning of the opening 26 over the imperfection 20. To facilitate application and handling, the left foil side is provided with a handle device 30 in form of a reinforced edge that is not self-adhesive. The protective foil 24 can have a different color and can also be transparent and can, depending on the color of the vehicle, also be used as a marking device for the lacquer imperfection to be removed or concealed. The protective foil in the present embodiments has a thickness of approximately 0.2 mm.

After the protective foil has been applied, the lacquer layer in the imperfect area is removed according to FIG. 3 by a vacuum sandblasting process, forming a crater down to the filler layer 14, whereby the inclusion 20 is simultaneously also partially or entirely removed, so that it does no longer extends beyond the coloring base lacquer 16 into the clear coat 18. The diameter of the removal area on the surface is defined by the diameter of the opening 26 of the protective foil and accordingly is approximately 2 mm. This diameter is only slightly larger than the inclusion 20 itself.

In the employed sandblasting process, the blasting material is directed by a vacuum via an acceleration path to the jet blasting, removal or repair location, whereby the removal speed and the depth and shape of the hereby formed lacquer indentation is controlled by the quantity of the abrading blasting material. The desired dose is achieved either by limiting the quantity of the available blasting material or by limiting the time of the blasting process during which the blasting material is continuously supplied. Alternatively, the formed lacquer indentation can also be controlled by the particle velocity and/or or the particle size and/or the actual blasting material. The vacuum not only suctions off the particles of the blasting material, but also the removed lacquer particles and the particles representing foreign inclusions, thereby reliably protecting both the nearby and more distant surrounding area of the repair location from potential damage caused by airborne particles. Other material removal methods, such as a laser process, can also be used for producing the desired crater-shaped indentation in the imperfect area and for partially or completely removing the lacquer imperfection.

After the lacquer has been removed and a crater-shaped indentation 22 of the desired shape and size has been formed in the imperfect area, the indentation 22 is first wiped with a soft cloth moistened using a mixture of isopropanol and distilled water to remove possibly adhering lacquer or dirt particles, before the repair lacquer 16a, 18a is applied according to the invention. However, other cleaning methods, such as blasting with compressed air and the like, can also be used.

After the so produced lacquer indentation 22 has been cleaned, as depicted in FIG. 4, a coloring base lacquer layer 16a is initially applied onto the inclined sidewalls and the bottom section of the indentation 22 with a precision spray device (not shown). Original base lacquer 16 of the original lacquer layer 12, 14, 16, 18 surrounding the repair location 22 or at least a lacquer of the same lacquer batch is used for obtaining an optimum repair result that would make the repair location 22 invisible to the human eye. This lacquer is collected and set aside when the original lacquer 12, 14, 16, 18 is applied, and stored for possible lacquer repairs at a later time.

After the base lacquer layer 16a has been applied in the indentation 22, the applied pressure-sensitive or self-adhesive protective foil 24 which protectively surrounds the lacquer repair location, is simply pulled off the lacquer layer and discarded, without leaving a residue on the lacquer layer.

Thereafter, the remaining portion of the indentation 22 is filled with clear coat 18a which represents a volume-filling material without a color appearance. The clear coat 18a is hereby applied sufficiently thick, so that the repair location 22, after the clear coat 18a has dried, has relative to the surface of the surrounding clear coat layer 18 a minimum deviation of at most a few micrometers, in particular a slightly increased height of less than approximately 1 μm, which is subsequently sanded down to the surrounding clear coat level and polished. The clear coat 18a is selected so that shrinkage after drying and any required sanding is at most 3 μm. So-called UV clear coats have proven to be particularly advantageous due to their excellent shrinkage characteristic.

In an alternative embodiment, the indentation 22 introduced into the lacquer 12, 14, 16, 18 in the imperfect area can be filled with a mixture of a base lacquer 16 and clear coat 18, whereby again original base lacquer 16 of the original lacquer 12, 14, 16, 18 surrounding the repair location 22 or at least a lacquer of the same lacquer batch is used for achieving optimum repair results. The mixing ratio between base lacquer 16 and clear coat 18 is hereby selected so that the mixture used as repair lacquer has a shrinkage that less than approximately 30%, preferably less than approximately 50%, of the shrinkage of the original base lacquer 16, which can be achieved by a high solid content of more than approximately 40%, in particular more than approximately 50%, which solid content is introduced into the repair lacquer by the clear coat 18 used to thin the base lacquer 16 and having a high solid content of approximately 60%. In the two embodiments of the process, the color appearance of the filled indentation 22 or the lacquer repair location 22 then corresponds essentially to the desired color appearance of the surrounding original lacquer 12, 14, 16, 18. According to the processes above, it is seen that the repair lacquer layer comprising a base lacquer layer and a clear coat is applied only within the perimeter of the indentation, and not the surrounding area.

After the lacquer indentation 22 has been filled with the repair lacquer 16a, 18a and the applied repair lacquer 16a, 18a has dried and its sanded down to the level of the surrounding clear coat 18, the repair location is oversprayed with the original base lacquer 16 to cover the color transitions, using a precision spray device. To limit the oversprayed area to a diameter of preferably less than 10 mm, the area surrounding the repair location 22 is shadowed by a mask 32. For this purpose, a pressure-sensitive or self-adhesive first foil 32a with a thickness of approximately 1 mm is initially applied to the surface of the original lacquer 12, 14, 16, 18, so that an opening 34 in the foil 32a with a diameter of approximately 8 mm is positioned over the repair location 22. Thereafter, a second foil 32b with a mask opening 36 of approximately 2 to 3 mm is adhesively attached to the first foil 32a, whereby the mask opening 36 is centered over the opening 34 the first foil 32a. Alternatively, the foils 32a, 32b can also be adhesively bonded together before their application and then applied as a unit of the repair location 22. The first foil 32a serves herein as a spacer for the second foil 32b. The spray diameter is determined by the mask opening 36. After the mask 32 is applied, the imperfect area is oversprayed with a thin base lacquer layer 16b having a thickness that is—depending on the employed color—approximately 5 to 75%, in particular approximately 5 to 50%, and preferably approximately 10 to 25%, of the layer thickness of the original base lacquer 16. The diameter of the oversprayed area is typically less than approximately 20 mm, in particular significantly less than approximately 10 mm, whereby the crater-shaped indentation has a diameter of approximately 2 to 4 mm. As a result of the spaced-apart arrangement of the mask opening 36 over the repair location 22, the edges of the oversprayed area gradually bleed, making them nearly invisible to the human eye. A visible edge would certainly remain if the foil 32b with the mask 32 were directly adhesively applied to the surrounding clear coat 18.

When the lacquer repair location is oversprayed, attention has to be paid that the color appearance of the sum of the number of particles of color pigments and/or effect pigments which is produced by the two overlapping lacquer applications 16a and 16b, corresponds to that of the surrounding lacquer 12, 14, 16, 18. Typically, approximately 75% to 90% of the original color appearance is already achieved by filling the indentation 22 with repair lacquer 16a and 18a, i.e., with base lacquer 16a and clear coat 18a. Overspraying with base lacquer 16b merely corrects the produced color appearance and/or appearance in reflection. The exact ratio is different between different color hues. If the lacquer indentation 22 is too light or covers insufficiently, i.e., is filled with a repair lacquer 16a, 18a with insufficient pigment density, then the oversprayed second color layer 16b has to be very dense so as to cover the repair location. If this results in a color layer 16b that is too thick, then it can become quite noticeable in the original lacquer 12, 14, 16, 18. Conversely, if the overspraying is insufficient, then the filled-in lacquer indentation 22 is visible through the second color layer 16b. The same situation occurs when the ratio between the repair lacquer 16a, 18a in the lacquer indentation 22 and the second color layer 16b or the second spot is too high. A crater filling that is to dark or a repair lacquer 16a, 18a that is too dark is almost impossible to correct by repainting, because the sum of the number of particles of color pigments over the circular lacquer repair location is larger than in the surface area. The same applies for correcting an excessive fraction of particles of effect pigments in the repair lacquer 16a, 18a.

After the applied base lacquer layer 16b has dried, the mask 32 is removed and the imperfect area is finally covered with a protective clear coat 18b and polished after drying. The result is illustrated in FIG. 5.

It will be understood that the method according to the invention is not limited to applications for removing lacquer imperfections in the automobile industry. The described method can advantageously be employed in all areas where it is desirable to remove point-shaped or small lacquer imperfections of the aforedescribed type over the smallest possible area without leaving visible marks. As already mentioned, this also applies in particular to curved surfaces.

### LIST OF REFERENCE NUMERALS

10 sheet metal
12 corrosion protection layer, KTL
14 filler layer
16 base lacquer layer
16a, 16b repair lacquer layer, base lacquer layer
18 clear coat
18a, 18b repair lacquer layer, clear coat
20 lacquer imperfection, inclusion
22 indentation, repair location
24 protective foil
26 opening
28 marker
30 handle device
32 mask
32a, 32b foil
34 opening
36 mask opening
a side length of the foil

What is claimed is:

1. Method for repairing lacquer imperfections of automobile body paints, comprising the steps of, in order, removing lacquer in an imperfect area down to a depth at which a lacquer imperfection is at least partially removed, and repainting an indentation produced by the removing step, wherein repainting includes filling at least one lacquer repair layer only within the perimeter of the indentation, overspraying the imperfect area with a coloring lacquer and applying a finish clear coat layer, wherein the lacquer is removed by a sandblasting process, and wherein the lacquer is removed in an area whose diameter is no greater than 10 times a diameter of the lacquer imperfection and no greater than 20 mm.

2. Method according to claim 1, wherein the removing step of the lacquer is controlled via a blasting means and/or a quantity of a blasting material and/or a velocity of the blasting material and/or a jet blasting time of the sandblasting process.

3. Method according to claim 1, wherein a sandblasting process is used, wherein a vacuum is used for accelerating blasting material and for suctioning off the blasting material and lacquer particles removed by said sandblasting.

4. Method for repairing lacquer imperfections of automobile body paints, comprising the steps of, in order, removing the lacquer in an imperfect area down to a depth at which a lacquer imperfection is at least partially removed, and repainting within an indentation produced by the removing step, wherein repainting consists of filling at least one repair lacquer layer only within the perimeter of the indentation, overspraying the imperfect area with a coloring lacquer and applying a finish clear coat layer, wherein the lacquer is removed in an area whose diameter is no greater than 10 times a diameter of the lacquer imperfection and no greater than 20 mm.

5. Method for repairing lacquer imperfections of automobile body paints, comprising the steps of, in order, removing the lacquer in an imperfect area down to a depth at which a lacquer imperfection is at least partially removed, and repainting an indentation produced by the removal, wherein repainting includes filling at least one repair lacquer layer within the perimeter of the indentation, overspraying the imperfect area with a coloring lacquer and applying a finish clear coat layer, and wherein the repair lacquer layer includes at least one of a coloring lacquer layer and a clear coat layer or a lacquer layer comprised of a mixture of a coloring lacquer and a clear coat, and wherein the lacquer is removed in an area whose diameter is no greater than 10 times a diameter of the lacquer imperfection and no greater than 20 mm.

6. Method according to claim 5, wherein a coloring lacquer of the original lacquer surrounding the area to be repaired or a coloring lacquer of the same lacquer batch is used as a coloring lacquer for the repair lacquer and/or as a coloring lacquer for overspraying.

7. Method according to claim 5, wherein a UV lacquer is used as the clear coat of the repair lacquer and/or for the finish clear coat layer.

8. Method according to claim 5, wherein the imperfect area is cleaned before a lacquer layer is applied.

9. Method according to claim 8, wherein an isopropanol/water mixture is used for cleaning.

10. Method according to claim 5, wherein the imperfect area is sanded and/or polished before and/or after overspraying and/or application of the finish clear coat layer.

11. Method according to claim 5, wherein a precision spray device is used for repainting.

12. Method according to claim 1, wherein a lacquer area surrounding the imperfect area is covered with a protective foil comprising an opening that leaves open only at most the imperfect area and an adjacent area within the opening, before one or more of steps chosen from lacquer being removed, sanded, polished and applied.

13. Method according to claim 4, wherein a lacquer area surrounding the imperfect area is covered with a protective foil comprising an opening that leaves open only at most the imperfect area and an adjacent area within the opening, before one or more of steps chosen from lacquer being removed, sanded, polished and applied.

14. Method according to claim 5, wherein a lacquer area surrounding the imperfect area is covered with a protective foil comprising an opening that leaves open only at most the imperfect area and an adjacent area within the opening, before one or more of steps chosen from lacquer being removed, sanded, polished and applied.

15. Method according to any of claims 12-14, wherein the lacquer area surrounding the imperfect area is covered with a protective foil before the lacquer is removed.

16. Method according to any of claims 12-14, wherein the opening in the protective foil corresponds to the measurements of the imperfect area.

17. Method according to any of claims 12-14, wherein the lacquer area surrounding the imperfect area is covered with a protective foil having an essentially circular opening disposed centrally over the imperfect area, the circular opening having a diameter of 0.5 to 4.0 mm.

18. Method according to any of claims 1, 4 and 5, wherein the diameter of the removal is no greater than 5 times the diameter of the lacquer imperfection.

19. Method according to any of claims 1, 4 and 5, wherein the lacquer is removed in an area having a diameter of between 0.5 and 20 mm.

20. Method according to claim 19, wherein the lacquer is removed in an area having a diameter of between 0.6 and 10 mm.

21. Method according to claim 20, wherein the lacquer is removed in an area having a diameter of between 0.7 and 4 mm.

22. Method according to claim 21, wherein the lacquer is removed in an area having a diameter of between 0.8 and 2 mm.

23. Method according to any of claims 1, 4 and 5, wherein the lacquer is removed down to a coloring base lacquer layer below a clear coat or to a filler layer located below the coloring base lacquer layer.

24. Method according to any of claims 1, 4 and 5, wherein the lacquer is removed to a depth of 55 to 75 μm relative to the surface.

25. Method according to any of claims 1, 4 and 5, wherein the removal produces a crater-like indentation with sides having a slope of 30 to 95°.

26. Method according to claim 25, wherein the removal produces a crater-like indentation with sides having a slope of 60 to 80°.

27. Method according to any of claims 4 and 5, wherein the lacquer is removed by one or more of drilling, milling, sanding and jet blasting.

28. Method for repairing lacquer imperfections of automobile body paints, comprising the steps of, in order, removing lacquer in an imperfect area down to a depth at which a lacquer imperfection is at least partially removed, and repainting an indentation produced by the removing step, wherein repainting includes filling at least one pigmented repair lacquer layer within the perimeter of the indentation, overspraying the imperfect area with a pigmented color lacquer and application of a finish clear coat layer, whereby a sum of the number of particles of color pigments and/or effect pigments of the repair lacquer layer applied in the indentation and of the oversprayed color lacquer layer corresponds to 85 to 115% of the sum of the number of particles of color pigments and/or effect pigments of the original lacquer surrounding the repair location, with reference to an axis oriented perpendicular to a lacquer surface.

29. Method according to claim 28, wherein the sum of the number of particles of color pigments and/or effect pigments of the repair lacquer layer and of the oversprayed color lacquer layer corresponds to 90 to 110% of the sum of the number of particles of color pigments and/or effect pigments of the surrounding original lacquer.

30. Method for repairing lacquer imperfections of automobile body paints, comprising the steps of, in order, removing lacquer in an imperfect area down to a depth at which a lacquer imperfection is at least partially removed, and repainting an indentation produced by the removing step, wherein repainting includes filling of at least one pigmented repair lacquer layer within perimeter of the indentation, overspraying the imperfect area with a pigmented color lacquer and application of a finish clear coat layer, whereby the fraction of color pigments and/or effect pigments of the repair lacquer layer applied in the indentation is selected so that a sum of the number of particles of color pigments and/or effect pigments of the repair lacquer layer corresponds to 50 to 95% of the sum of the number of particles of color pigments and/or effect pigments of a color lacquer layer of the original lacquer surrounding the repair location, with reference to an axis oriented perpendicular to a lacquer surface.

31. Method according to claim 30, wherein the sum of number of particles of the color pigments and/or effect pigments of the repair lacquer layer applied in the indentation corresponds to 65 to 92% of the sum of the number of particles of color pigments and/or effect pigments of the original lacquer.

32. Method according to claim 31, wherein the sum of the number of particles of color pigments and/or effect pigments of the repair lacquer layer corresponds to 75 to 90% of the sum of the number of particles of color pigments and/or effect pigments of the original lacquer.

33. Method according to claim 30, wherein the sum of the number of particles of color pigments and/or effect pigments of the color lacquer layer oversprayed over the repair lacquer layer is selected so that it supplements a difference of the number of particles of color pigments and/or effect pigments between the original lacquer layer and the repair lacquer layer.

34. Method according to claim 30, wherein a brightness of the repair lacquer layer is greater than or equal to a brightness of the original lacquer layer surrounding the repair location.

35. Method according to claim 30, wherein at least 80% of the particles of effect pigments of the repair lacquer layer assume after drying an orientation that is essentially parallel to an orientation of the particles of effect pigments of an original lacquer layer surrounding the repair location, and overspraying is carried out with a color lacquer covering the repair lacquer, wherein a color lacquer is applied which has a greater pigment density than the repair lacquer.
